(19) United States
(12) Patent Application Publication
(10) Pub. No.: US 2010/0284618 A1
(43) Pub. Date: Nov. 11, 2010

(54) METHOD AND SYSTEM FOR IDENTIFYING AN OBJECT

(76) Inventors: Dimitrios Ioannou, Fremont, CA (US); Matthew Merzbacher, Oakland, CA (US); Todd Gable, Newark, CA (US)

Correspondence Address: PATRICK W. RASCHE (22697);ARMSTRONG TEASDALE LLP, 7700 Forsyth Boulevard, Suite 1800, St. Louis, MO, 63105, US

(21) Appl. No.: 11/967,425

(22) Filed: Dec. 31, 2007

(51) Int. Cl. G06K 9/46

(52) U.S. Cl. 382/190

(57) ABSTRACT

A method for identifying an object is provided. The method includes acquiring image data, and separating a sheet object from a bulk object within the acquired image data by using a top hat algorithm. Information relating to at least one of the sheet object and the bulk object is outputted.

### FIELD OF THE INVENTION

The embodiments described herein relate generally to identifying a shape of an object and, more particularly, to identifying the shape of an object within a container to facilitate detecting contraband concealed within the container.

### BACKGROUND OF THE INVENTION

Known identification systems can image a container to determine whether explosives, drugs, weapons, and/or other contraband are present within the container. Some of the known systems are configured to determine whether a thin object is present within the container. At least one known method for detecting objects in computed tomography (CT) data, including sheet-shaped, or thin, objects such as sheet explosives, includes analyzing a neighborhood of voxels surrounding a test voxel and eroding the data by identifying a neighborhood of voxels surrounding a voxel of interest. In such a method, if the number of voxels having densities below a threshold exceeds a predetermined number, then it is assumed that the test voxel is a surface voxel and is removed from the object. The known method also includes applying a connectivity process to voxels to combine them into objects after sheets are detected to prevent sheets from being inadvertently removed from the data by erosion. A dilation function can then be performed on the eroded object to replace surface voxels removed by erosion. However, such known methods may generate false alarms because random pixels are connected and are then identified as a thin object, when no thin object exists.

Other known identification methods use density and/or atomic number to identify components of a multi-component object, but are not specifically directed to identifying a thin object. Known systems and methods may be capable of detecting thin object in non-cluttered environments, however such systems and methods may not identify a thin object when the thin object intersect with objects that are larger than the thin object.

### BRIEF DESCRIPTION OF THE INVENTION

In one aspect, a method for identifying an object is provided. The method includes acquiring image data, and separating a sheet object from a bulk object within the acquired image data by using a top hat algorithm. Information relating to at least one of the sheet object and the bulk object is displayed.

In another aspect, a system for identifying an object is provided. The system includes a data collection system configured to acquire image data, and a detection classification system operatively coupled to the data collection system. The detection classification system is configured to receive acquired image data, and separate a sheet object from a bulk object within the acquired image data by using a top hat algorithm. Information relating to at least one of the sheet object and the bulk object is outputted.

In still another aspect, a computer program embodied on a computer-readable medium is provided. The computer program includes a code segment that configures a processor to receive acquired image data, and separate a sheet object from a bulk object within the acquired image data by using a top hat algorithm. Information relating to at least one of the sheet object and the bulk object is outputted.

### BRIEF DESCRIPTION OF THE DRAWINGS

FIGS. 1, 2, 3, and 4 show exemplary embodiments of the systems and methods described herein.

FIG. 1 is a block diagram of an exemplary detection classification system.

FIG. 2 is a flowchart of an exemplary embodiment of a method for classifying an object that may be used with the detection classification system shown in FIG. 1.

FIG. 3 is a flowchart of an exemplary embodiment of a method for sheet breaking that may be used with the method shown in FIG. 2.

FIG. 4 is a flowchart of an exemplary embodiment of a method for object correction that may be used with the method shown in FIG. 3.

### DETAILED DESCRIPTION OF THE INVENTION

The embodiments described herein provide systems and methods for processing the output of an imaging system that includes a detection and/or classification component, and for determining the shape of a thin object or a sheet object. In one embodiment, a detection classification system receives images from an imaging system. Using image elements making up the images, the detection classification system breaks a sheet object from a bulk object. An image of the sheet object and/or the image of the bulk object may be corrected and further processed to determine if explosives, narcotics, weapons, and/or other contraband is present within a container.

A technical effect of the systems and methods described herein is to reduce the occurrence of false alarms by discriminating the shape of a detected object and/or to recognize a thin object within a container. An embodiment of a method uses a top hat algorithm and correction algorithm to identify possible thin object shapes. As used herein, the term “top hat algorithm” refers to an algorithm than extracts structures and/or components present within an image. Further, an embodiment of a correction algorithm reassigns at least one image element from the bulk object to the sheet object. As used herein, the term “image element” refers to an element within an image, such as a pixel and/or a voxel. In one embodiment, the correction algorithm determines a set of candidate image elements, wherein the set of candidate image elements includes at least one image element that is a candidate for reassignment. Embodiments of the systems and methods described herein may be used to facilitate avoiding misidentification associated with sheet objects, such as identifying portions of sheet objects as a portion of a bulk object, by discriminating between sheets and bulk objects. As used herein, the term “sheet object” may be used interchangeably with “thin object,” “sheet,” and/or “sheet-like object,” and any variations thereof, are used interchangeably to designate an object having a relatively smaller width as compared to its length and height. One example of a sheet object is a page within a book and/or a data representation of the page within the book. Further, as used herein, the term “bulk object” refers to an object having a distinct mass or portion of matter, particularly a large one, such that a bulk object is a main or larger object within a container. A bulk object does not have a dimension that is relatively much smaller as compared to the bulk object's other dimensions. In the above example, the book is a bulk object.

At least one embodiment of the present invention is described below in reference to its application in connection with and operation of a system for inspecting cargo. However, it should be apparent to those skilled in the art and guided by the teachings herein provided that the invention is likewise applicable to any suitable system for scanning cargo containers including, without limitation, crates, boxes, drums, baggage, containers, luggage, and suitcases, transported by water, land, and/or air, as well as other containers and/or objects.

Moreover, although the embodiments described below are in reference to an application in connection with and operation of a system incorporating an X-ray computed tomography (CT) scanning system for inspecting cargo, it should apparent to those skilled in the art and guided by the teachings herein provided that any suitable radiation source including, without limitation, neutrons or gamma rays, may be used in alternative embodiments. Further, it should be apparent to those skilled in the art and guided by the teachings herein provided that any scanning system may be used that produces a sufficient number of pixels and/or voxels to enable the functionality of the detection classification system described herein. For example, the system and methods described may be used for automatic detection of thin structures in volumetric data in any other suitable application, such as, but not limited to, medical imaging.

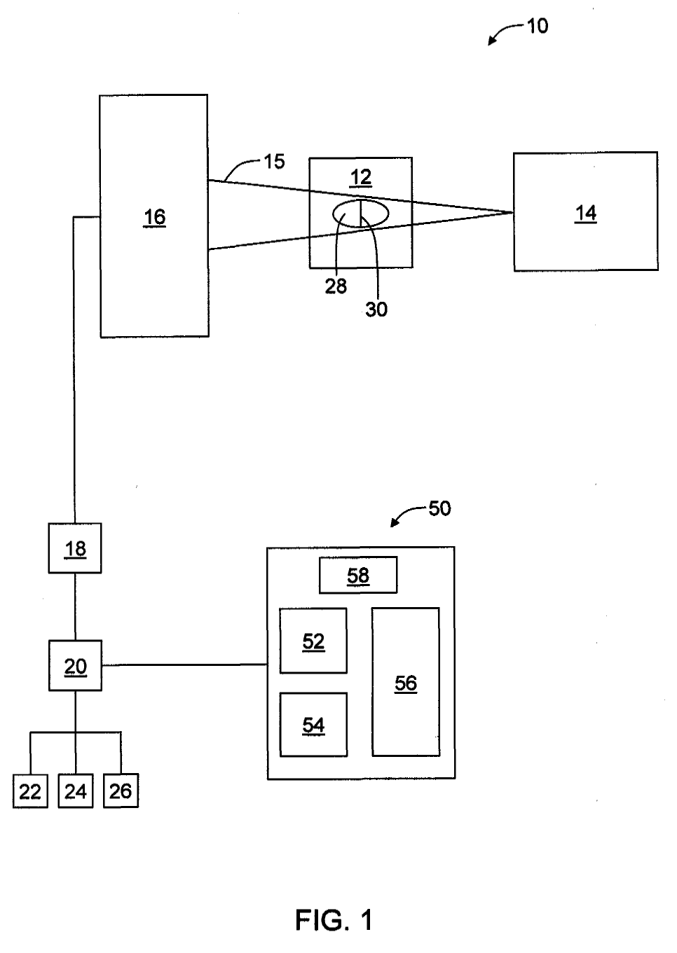

FIG. 1 is a block diagram of an exemplary detection classification system 50 used with an X-ray computed tomography (CT) scanning system 10 (also referred to herein as an “imaging system”) for scanning a container 12, such as a cargo container, box, parcel, luggage, or suitcase, to identify the contents and/or determine the type of material contained within container 12. The term “contents” as used herein refers to any object and/or any material contained within container 12 and may include contraband.

In one embodiment, scanning system 10 includes at least one X-ray source 14 configured to transmit at least one primary beam 15 of radiation through container 12. In an alternative embodiment, scanning system 10 includes a plurality of X-ray sources 14 configured to emit radiation of different energy distributions. Alternatively, each X-ray source 14 is configured to emit radiation of selective energy distributions, which can be emitted at different times. In a particular embodiment, scanning system 10 utilizes multiple-energy scanning to obtain an attenuation map for container 12. In addition to the production of CT images, multiple-energy scanning enables the production of density maps and/or atomic number information of the object contents. In one embodiment, the dual energy scanning of container 12 includes inspecting container 12 by scanning container 12 at a low energy and then scanning container 12 at a high energy. The data is collected for the low-energy scan and the high-energy scan to reconstruct the CT, density, and/or atomic number images of container 12 to facilitate identifying the type of material within container 12 based on the material content of container 12 to facilitate detecting contraband concealed within container 12, as described in greater detail below.

In one embodiment, scanning system 10 also includes at least one X-ray detector 16 configured to detect radiation emitted from X-ray source 14 and transmitted through container 12. X-ray detector 16 is configured to cover an entire field of view or only a portion of the field of view. Upon detection of the transmitted radiation, X-ray detector 16 generates a signal representative of the detected transmitted radiation. The signal is transmitted to a data collection system and/or processor as described below. Upon detection of the transmitted radiation, each X-ray detector element generates a signal representative of the detected transmitted radiation. The signal is transmitted to a data collection system and/or processor as described below. Scanning system 10 is utilized to reconstruct a CT image of container 12 in real time, non-real time, or delayed time.

In one embodiment of scanning system 10, a data collection system 18 is operatively coupled to and in signal communication with X-ray detector 16. Data collection system 18 is configured to receive the signals generated and transmitted by X-ray detector 16. A processor 20 is operatively coupled to data collection system 18. Processor 20 is configured to produce or generate one or more images of container 12 and its contents and to process the produced image(s) to facilitate determining the material content of container 12. More specifically, in one embodiment, data collection system 18 and/or processor 20 produces at least one attenuation map based upon the signals received from X-ray detector 16. Utilizing the attenuation map(s), at least one image of the contents is reconstructed and a CT number, a density, and/or an atomic number of the contents is inferred from the reconstructed image(s). Based on these CT images, density and/or atomic maps of container 12 can be produced. The CT, density, and/or atomic number images are analyzed to infer the presence of contraband including, without limitation, explosives and/or explosive material.

In alternative embodiments of scanning system 10, one processor 20 or more than one processor 20 may be used to generate and/or process the container image(s). In the exemplary embodiment, scanning system 10 also includes a display device 22, a memory device 24 and/or an input device 26 operatively coupled to data collection system 18 and/or processor 20. As used herein, the term “processor” is not limited to only integrated circuits referred to in the art as a processor, but broadly refers to a computer, a microcontroller, a microcomputer, a programmable logic controller, an application specific integrated circuit and any other programmable circuit. The processor 20 may also include a storage device and/or an input device, such as a mouse and/or a keyboard.

During operation of one embodiment of scanning system 10, X-ray source 14 emits X-rays in an energy range, which is dependent on a voltage applied by a power source to X-ray source 14. A primary radiation beam 15 is generated and passes through container 12, and X-ray detector 16, positioned on the opposing side of container 12, measures an intensity of primary radiation beam 15.

Images generated by scanning system 10 are then processed by detection classification system 50 to determine whether container 12 includes suspected contraband. More specifically, detection classification system 50 uses the data within the images to identify objects 28 and/or 30 within container 12 as a sheet object and/or a bulk object. In the exemplary embodiment, detection classification system 50 includes one or more processors 52 electrically coupled to a system bus (not shown). Detection classification system 50 also includes a memory 54 electrically coupled to the system bus such that memory 54 is communicatively coupled to processor 52. Detection classification system 50 also includes a display device 58, which may be, but is not limited to being, a monitor (not shown), a cathode ray tube (CRT) (not shown), a liquid crystal display (LCD) (not shown), and/or any other suitable output device that enables system 50 to function as described herein. Detection classification system 50 may also include a storage device and/or an input device, such as a mouse and/or a keyboard. In the exemplary embodiment, the results of detection classification system 50 are output to a memory, such as memory 54, a drive (not shown), a display device, such as display device 58, and/or any other suitable component.

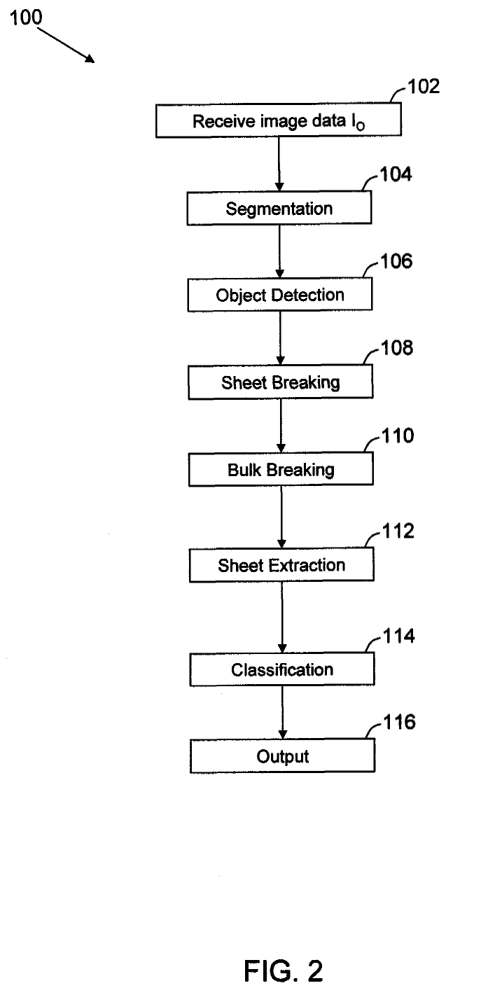

FIG. 2 shows a flowchart illustrating a method 100 for classifying object 28 and/or 30 (shown in FIG. 1) as a sheet object using detection classification system 50 (shown in FIG. 1). In the exemplary embodiment, method 100 is implemented on system 10 and/or system 50, however, method 100 is not limited to implementation on system 10 and/or system 50. Rather, method 100 may be embodied on a computer readable medium as a computer program and/or implemented and/or embodied by any other suitable means. The computer program may include a code segment that, when executed by a processor, configures the processor to perform one or more of the functions of method 100. Furthermore, although the method 100 is described as being used with voxels, the method 100 may also be used with pixels and/or any suitable image element. As used herein, the term “image element” refers to an element, such as a pixel and/or voxel, within image data.

An original image I_{O} is initially received 102 by the detection classification system 50 (shown in FIG. 1). Alternatively, original image I_{O} is received 102 by any suitable system that enables method 100 to be implemented. Original image I_{O} is segmented 104 into image segments I_{S} using any suitable segmenting technique, such as, for example, thresholding. In the exemplary embodiment, image segments I_{S} are used to detect 106 objects within original image I_{O}. As such, objects are detected 106 within a container, such as container 12 (shown in FIG. 1). In the exemplary embodiment, objects are detected 106 as being bulk objects I_{B} or sheet objects I_{T}.

Further, in the exemplary embodiment, sheet objects I_{T} are broken 108 out of bulk objects I_{B}, as described in more detail below. Bulk objects I_{B} are also broken 110. For example, a bulk object I_{B} may be broken 110 into two or more objects when a region is undersegmented, such as when two or more dissimilar regions are segmented as one bulk object I_{B}. Further, during bulk breaking 110, a sheet object may be separated from a bulk object. In the exemplary embodiment, if sheet breaking 108 and/or bulk breaking 110 is not sufficient to classify an object as being suspicious or innocent, sheet extraction is performed 112 to separate sheet object I_{T} from bulk object I_{B}. Once a sheet object I_{T} is broken 108 and/or 110, and/or extracted 112 from bulk object I_{B}, sheet object I_{T} is classified 114 according to predetermined criteria. In one embodiment, sheet object I_{T} is classified 114 using any suitable feature of sheet object I_{T}. Suitable features may include, for example, but not limited to including, physical features, such as mass and/or density of sheet object I_{T}, to determine if sheet object I_{T} meets the predetermined criteria. Further, in the exemplary embodiment, the predetermined criteria is selected to classify 114 a threat level of a sheet object I_{T} and/or a bulk object I_{B} and/or to classify 114 a sheet object I_{T} and/or a bulk object I_{B} as being, for example, suspicious or innocent.

The results of the classification of the sheet object I_{T} and/or bulk object I_{B} are output 116 to a memory, such as memory 54 (shown in FIG. 1), a drive (not shown), a display device, such as display device 58 (shown in FIG. 1), and/or any other suitable component. More specifically, the results of the classification include information relating to the sheet object I_{T} and/or the bulk object I_{B} are output 116. Information relating to the sheet object I_{T} and/or the bulk object I_{B} includes, but is not limited to including, an image, an indication of a characteristic of the object, an alarm, and/or any other suitable information. In one embodiment, a classification of object 28 and/or 30 is output 116 such that the classification is displayed to an operator and/or stored in computer-readable memory.

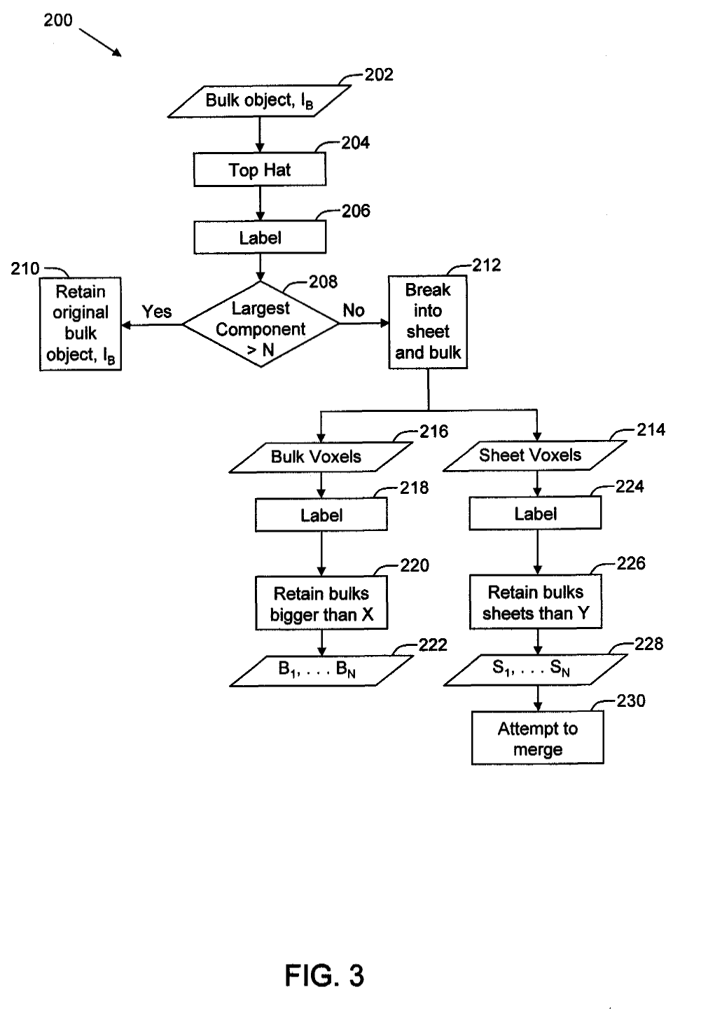

FIG. 3 is a flowchart of an exemplary embodiment of a method 200 for sheet breaking 108 (shown in FIG. 2) that may be used with method 100 (shown in FIG. 2) and original image I_{O}. In the exemplary embodiment, an image of a bulk object I_{B} 202 is processed using method 200. Bulk object I_{B} 202 is a labeled image segment I_{S} generated by method 100, described above. First, a top hat algorithm is performed 204 on bulk object I_{B} 202 to extract structures and/or components from bulk object I_{B} 202. More specifically, the top-hat algorithm breaks a sheet object, which is grouped together with a bulk object, away from the bulk object. For example, given a width of a sheet object that is to be detected, the number of erosions that are needed to fully erode the sheet object can be calculated. As used herein, the term “erosion” refers to a morphological operator that removes image elements, such as pixels and/or voxels, from the object under investigation. For example, an erosion may remove neighboring image elements of the image elements belonging to the object from the group of image elements to be processed in order to determine one or more characteristics of the object. Accordingly, in the exemplary embodiment, the top hat algorithm erodes the sheet structures and/or components out of the bulk structure without destroying or significantly altering potential bulk threats. In one embodiment, multiple top-hat transformations having different numbers of erosions and/or dilations are used to detect thin objects of various thicknesses. As used herein, the term “dilation” refers to a morphological operator that adds image elements to the object under investigation. For example, a dilation may add neighboring image elements of the image elements belonging to the object to the group of image elements to be processed in order to determine one or more characteristics of the object.

The components of bulk object I_{B} 202 are then labeled 206 to identify the potential presence of a sheet object. More specifically, in the exemplary embodiment, components are labeled 206 to determined which components are connected to each other. If one of the resulting connected components has a predetermined size, a sheet is present within bulk object I_{B} 202. Each component is then compared 208 to predetermined criteria. In the exemplary embodiment, each component is compared 208 to a threshold number N to determine if the largest component is greater than N. If the largest component is greater than N, bulk object I_{B} 202 is retained 210 and used in method 100. If the largest component is not greater than N, bulk object I_{B} 202 is broken 212 into at least one group of sheet voxels 214 and at least one group of bulk voxels 216 for further processing.

In the exemplary embodiment, bulk voxels 216 are labeled 218 to determine whether bulk voxels 216 belong to one bulk entity or to multiple bulk entities. Bulk entities that are bigger than a threshold X are retained 220, and bulk entities smaller than threshold X are discarded (not shown) because, for example, bulk entities smaller than threshold X are not large enough to be a threat. In the exemplary embodiment, threshold X is selected based on the size of contraband to be detected. As such, method 200 generates at least one bulk B₁ 222 such as a plurality of bulks B₁, . . . , B_{N} 222.

Similarly, in the exemplary embodiment, sheet voxels 214 are labeled 224 to determine whether sheet voxels 214 belong to one sheet entity or to multiple sheet entities. Sheet entities that are bigger than a threshold Y are retained 226, and sheet entities smaller than threshold Y are discarded (not shown) because, for example, sheet entities smaller than threshold Y are not large enough to be a threat. In the exemplary embodiment, threshold Y is selected based on the size of contraband to be detected. As such, method 200 generates at least one sheet S₁ 228 such as a plurality of sheets S₁, . . . , S_{N} 228.

Moreover, in the exemplary embodiment, sheets 228 belonging to the same object are merged 230 into a single object based on a predetermined criteria and threshold Y. In one embodiment, the predetermined criteria may be size, mass, density, and/or any other suitable criteria for merging 230 sheets. For example, method 200 may merge 230 pages (not shown) of a book (not shown) into a book object (not shown) within container 12 (shown in FIG. 1) while maintaining a sheet explosive (not shown) within the book as a separate object (not shown) from the book object. Bulks B₁, . . . , B_{N} 222, sheets S₁, . . . , S_{N} 228 and/or merged sheet objects may then used within method 100 (shown in FIG. 2). However, in the exemplary embodiment, bulks B₁, . . . , B_{N} 222 and/or sheets S₁, . . . , S_{N} 228 are corrected before use within method 100.

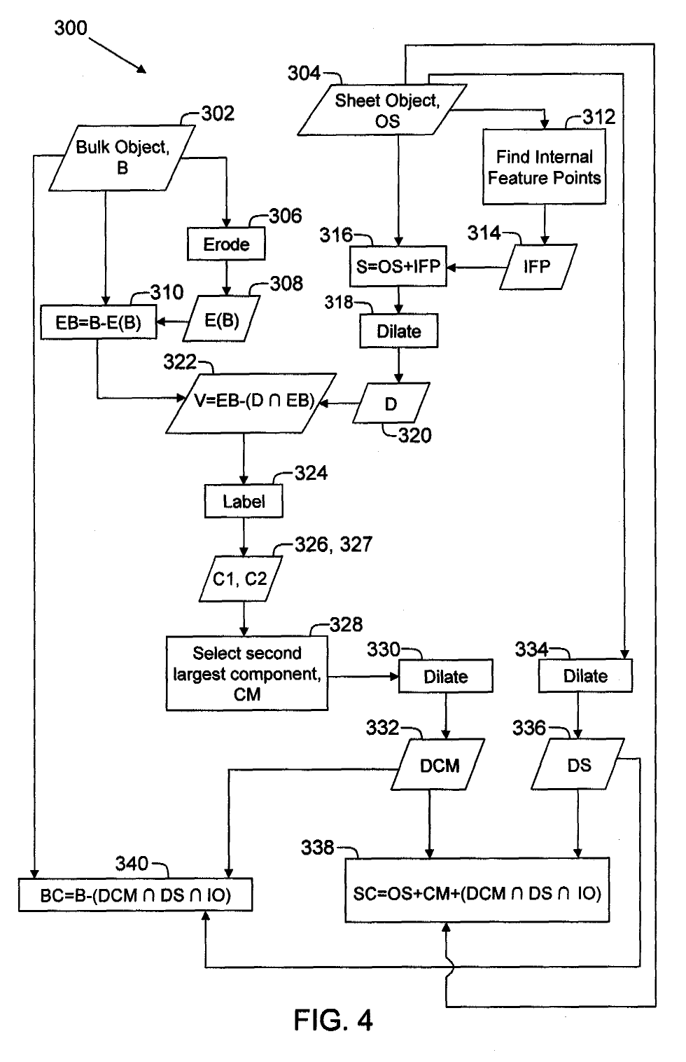

FIG. 4 is a flowchart of an exemplary embodiment of a method 300 for object correction that may be used with method 200 (shown in FIG. 3). The object correction method 300 facilitates determining which voxels are candidates for being assigned from a bulk 222 (shown in FIG. 3) back into a sheet 228 (shown in FIG. 3), or from a bulk object I_{B} back into a sheet object I_{T}. For example, if some voxels of a sheet object are assigned to a bulk object, method 300 facilitates correctly identifying the voxels that belong to the sheet object. In the exemplary embodiment, a bulk object B 302 and a sheet object OS 304 are corrected using method 300. In one embodiment, bulk object B 302 is one of the bulks B₁, . . . , B_{N} 222, and/or sheet object OS 304 may be one of the sheets S₁, . . . , S_{N} 228 found using method 200.

In the exemplary embodiment of correction method 300, bulk object B 302 is eroded 306 to generate an eroded bulk E(B) 308. More specifically, in the exemplary embodiment, the erosion 306 removes voxels on the boundary of bulk object B 302, and eroded bulk E(B) 308 is bulk object B 302 without the boundary voxels. Eroded bulk E(B) 308 is subtracted from bulk object B 302 to generate 310 a set of voxels EB that are at the perimeter of bulk object B 302.

In the exemplary embodiment, internal feature points IFP 312 are found 314 within sheet object OS 304. More specifically, in the exemplary embodiment, sheet object OS 304 includes feature-point holes, which are holes in sheet object OS 304 where points that should be included in a sheet object have been omitted from the sheet object. As such, in the exemplary embodiment, the internal feature-point holes are found 312 to generate a set of internal feature points (IFP) 314 that correspond to the points omitted at the feature-point holes. IFP 314 are added into sheet object OS 304 to generate 316 a corrected sheet object S, which includes the points that were omitted in sheet object OS. The corrected sheet object S is dilated 318 to identify voxels that are proximate to the boundary of corrected sheet object S. A dilated sheet D 320 is created through the dilation 318 of corrected sheet object S.

A set of candidate voxels V is generated 322, in the exemplary embodiment, by subtracting the intersection of dilated sheet D 320 and the set of bulk perimeter voxels EB from the set of bulk perimeter voxels EB. As such, the set of candidate voxels V includes voxels that belong to the perimeter of bulk object B 302 but not to the dilated sheet D 320. The set of candidate voxels V is then labeled 324. In the exemplary embodiment, the set of candidate voxels V is labeled 324 to represent a first component C1 326 and a second component C2 327. A second largest component CM is selected 328 from components C1 326 and C2 327.

In the exemplary embodiment, the selected component CM is dilated 330 to generate 332 a dilated component DCM. Further, in the exemplary embodiment, sheet object OS 304 is dilated 334 to generate 336 a dilated sheet DS. A corrected sheet SC is generated 338 by adding sheet object OS 304, selected component CM and the intersection of dilated component DCM 332 with dilated sheet DS 336 intersected with original image I_{O} (shown in FIG. 2). Furthermore, a corrected bulk BC is generated 340 by subtracting the intersection of dilated component DCM 332 with dilated sheet DS 336 intersected with original image I_{O} from bulk object B 302. As such, corrected sheet SC includes voxels that were initially included in bulk 222 and corrected bulk BC 340 has voxels removed that should have been included in the thin sheet 228. Alternatively, corrected sheet SC includes voxels that were initially detected 106 (shown in FIG. 2) as belonging to bulk object I_{B}, and corrected bulk BC has voxels removed that should have been detected 106 as belonging to sheet object I_{T}. Corrected bulk BC and/or corrected sheet CS is then used in steps 110, 112, 114, and/or 116 (shown in FIG. 2) of method 100 (shown in FIG. 2).

The above-described systems and methods for identifying a thin object, or a sheet object, facilitate improving the reliability of detecting a thin object by more accurately determining the boundaries of the thin object. More specifically, because the top hat algorithm erodes out the sheet objects without significantly destroying and/or altering the bulk objects, the systems and methods described herein identify more thin objects that are in contact with the bulk object, as compared to known thin object identification methods and/or systems. Furthermore, the methods described herein include a correction method to ensure that voxels belonging to a thin object are included in the data representation of the thin object. By ensuring that voxels are properly assigned to data segments within an image, the properties and/or features, such as mass and/or density, of the thin object are more accurately determined, as compared to known thin object identification methods and/or systems that may underestimate a thin object by including thin object voxels within a bulk object. As such, the above-described systems and methods facilitate more accurately determining if a thin threat object is present within a container and increases sheet detection rates, as compared to known methods and/or systems for object identification.

Furthermore, automated explosive and/or contraband detection in a unpredictable unstructured environment, such as passenger luggage, may be especially difficult using known methods and/or system. The above-described systems and methods are directed to identification of thin objects that are proximate to a bulk object, which is one of the more difficult detection issues in unstructured environments. More specifically, the above-described systems and methods are directed to thin shape recognition, thin-bulky region breaking, processing induced error correction, and bulk post processing for sheet extraction.

Exemplary embodiments of methods and systems for identifying a thin object are described above in detail. The methods and systems are not limited to the specific embodiments described herein, but rather, components of the systems and/or steps of the methods may be utilized independently and separately from other components and/or steps described herein. For example, the methods may also be used in combination with other imaging systems and methods, and are not limited to practice with only the classification system as described herein. Rather, the present invention can be implemented and utilized in connection with many other identification and/or classification applications. The exemplary embodiment may also be used in other fields (i.e., medical) and/or be used in applications directed to thin object detection in cluttered environments.

Although specific features of various embodiments of the invention may be shown in some drawings and not in others, this is for convenience only. In accordance with the principles of the invention, any feature of a drawing may be referenced and/or claimed in combination with any feature of any other drawing.

While the methods and system described herein have been described in terms of various specific embodiments, those skilled in the art will recognize that the methods and systems described herein can be practiced with modification within the spirit and scope of the appended claims.

What is claimed is:

1. A method for identifying an object, said method comprising:
acquiring image data;
separating a sheet object from a bulk object within the acquired image data by using a top hat algorithm; and
outputting information relating to at least one of the sheet object and the bulk object.

2. A method in accordance with claim 1, wherein separating s sheet object from a bulk object further comprises identifying a plurality of components within the bulk object.

3. A method in accordance with claim 2, further comprising determining any connected components of the plurality of components.

4. A method in accordance with claim 2, further comprising comparing the plurality of components to a threshold.

5. A method in accordance with claim 2, further comprising separating at least one component of the plurality of components into at least one sheet and at least one bulk.

6. A method in accordance with claim 5, further comprising comparing the at least one sheet to a sheet threshold and comparing the at least one bulk to a bulk threshold.

7. A method in accordance with claim 1, further comprising correcting the sheet object and the bulk object by reassigning at least one image element from the bulk object to the sheet object.

8. A method in accordance with claim 7, wherein correcting the sheet object and the bulk object further comprises determining a set of candidate image elements, wherein the set of candidate image elements comprises at least one image element that is a candidate for reassignment.

9. A method in accordance with claim 8, wherein correcting the sheet object and the bulk object further comprises identifying a component within the set of candidate image elements.

10. A method in accordance with claim 7, wherein correcting the sheet object and the bulk object further comprises:
determining a set of image elements to be reassigned from the bulk object to the sheet object; and
reassigning the determined set of image elements from the bulk object to the sheet object.

11. A method in accordance with claim 1, further comprising classifying at least one of the sheet object and the bulk object to determine a threat level of at least one of the sheet object and the bulk object.

12. A system for identifying an object, said system comprising:
a data collection system configured to acquire image data; and
a detection classification system operatively coupled to said data collection system, said detection classification system configured to:
receive acquired image data;
separate a sheet object from a bulk object within the acquired image data by using a top hat algorithm; and
output information relating to at least one of the sheet object and the bulk object.

13. A system in accordance with claim 12, wherein said detection classification system is further configured to correct at least one of the sheet object and the bulk object.

14. A system in accordance with claim 12, wherein said detection classification system is further configured to classify at least one of the sheet object and the bulk object.

15. A system in accordance with claim 12, wherein said detection classification system is further configured to:
identify at least one component within the bulk object; and
separate the at least one component into at least one sheet and at least one bulk.

16. A system in accordance with claim 12, wherein said detection classification system is further configured to:
determine a set of image elements to be reassigned from the bulk object to the sheet object; and
reassign the set of image elements from the bulk object to the sheet object.

17. A computer program embodied on a computer-readable medium, said computer program comprising a code segment that configures a processor to:
receive acquired image data;
separate a sheet object from a bulk object within the acquired image data by using a top hat algorithm; and
output information relating to at least one of the sheet object and the bulk object.

18. A computer program in accordance with claim 17, wherein the code segment further configures the processor to correct at least one of the sheet object and the bulk object by determining a set of image elements to be reassigned from the bulk object to the sheet object and reassigning the set of image elements from the bulk object to the sheet object.

19. A computer program in accordance with claim 17, wherein the code segment further configures the processor to classify at least one of the sheet object and the bulk object using physical features of the least one of the sheet object and the bulk object.

20. A computer program in accordance with claim 17, wherein the code segment further configures the processor to erode the sheet object from the bulk object.
